(19) United States
(12) Patent Application Publication
(10) Pub. No.: US 2003/0134088 A1
(43) Pub. Date: Jul. 17, 2003

(54) Rubber/cloth laminate grip tape for handle

(76) Inventors: Sam H. Chen, San Diego, CA (US); C.F. Chang, Taichung (TW)

Correspondence Address: CALIF KIP TERVO, 6387 CAMINITO LAZARO, SAN DIEGO, CA, 92111, US

(21) Appl. No.: 10/045,751

(22) Filed: Jan. 16, 2002

(51) Int. Cl. B32B 7/02

(52) U.S. Cl. 428/156; 428/212

(57) ABSTRACT

A grip tape 10 for applying to a handle 94 generally comprises an elongate tape having an upper portion 50 comprised of shock absorbing, compressible, elastic rubber 51 bonded to a shock absorbing cloth lower portion 85 less elastic than rubber 51, such as of open-pored material, such as of felt 86. Tape 10 includes bottom 25, of two-sided tape 99, and top 20. In lateral cross section, rubber 51 includes central portion 60 having upper surface 62, right edge portion 70 having upper surface 72 lower than central portion upper surface 62, and left edge portion 80 having upper surface 82 lower than central portion upper surface 62. Preferably, lower portion 85 is substantially longitudinally inelastic and includes skived right portion 87 and skived left portion 88. Tape 10 is spiral wrapped around handle 94 such that right edge portion 70 overlies left edge portion upper surface 82 of the previous turn.

### FIELD OF THE INVENTION

This invention relates in general to an improved grip tape for the handle of a racquet or other device that is subject to shock when the device is impacted, such as a hammer, golf club, or baseball bat, and more specifically to a rubber/cloth laminate grip tape.

### BACKGROUND OF THE INVENTION

Grip tape for wrapping a racquet handle to enhance grip and to reduce shock is well known. Various materials have been used to wrap a handle, including a rubber strip. Rubber provides cushioning and has a tacky gripping surface.

However, rubber grip tape has several drawbacks that have kept it from general use. Rubber tape is very elastic such that the final configuration and properties of a finished wrapped grip is highly dependent upon the tension used during the wrap. High wrapping tension elongates the rubber, makes it more narrow and thinner. Thin sections have reducing cushioning properties. Narrow sections may not properly overlap the underlying wrap.

With low wrapping tension, the rubber of a wrapped grip is easily locally stretched such that the grip will tend to rotate in the user's hand. Inconsistent wrapping tension results in a combination of these undesirable traits.

It would be desirable to produce a grip tape that uses the desirable characteristics of rubber without the major drawbacks.

### SUMMARY OF THE INVENTION

This invention is a grip tape for applying to a handle and it generally comprises an elongate tape having an upper portion comprised of shock absorbing, compressible, elastic rubber bonded to a shock absorbing cloth lower portion less elastic than rubber, such as of open-pored material, such as of felt. The tape has a top, a bottom, a left side and a right side. Preferably, in lateral cross section, the rubber includes a central portion having an upper surface, a right edge portion having an upper surface lower than the upper surface of the central portion, and a left edge portion having an upper surface lower than the upper surface of the central portion.

Preferably, the lower portion is substantially longitudinally inelastic and includes a skived right portion and a skived left portion. The bottom is covered with two-sided tape.

The tape is spiral wrapped around said handle such that the right edge portion overlies the upper surface of the left edge portion of the previous turn.

Other features and many attendant advantages of the invention will become more apparent upon a reading of the following detailed description together with the drawings in which like reference numerals refer to like parts throughout.

### BRIEF DESCRIPTION OF THE DRAWINGS

FIG. 1 is a perspective view of the handle of a sporting racquet with an exemplary embodiment of the tape spiral wound around it according to the invention.

FIG. 2 is an enlarged lateral cross sectional view, partially cut away, of a first embodiment of the grip tape.

FIG. 3 is a lateral cross sectional view taken on line 3-3 of FIG. 1, partially cut away, of a preferred embodiment of the tape of FIG. 1.

FIG. 4 is a cross sectional view, partially cut away, taken on line 4-4 of FIG. 1 showing a preferred embodiment of the wrapping of the tape.

### DETAILED DESCRIPTION OF THE INVENTION

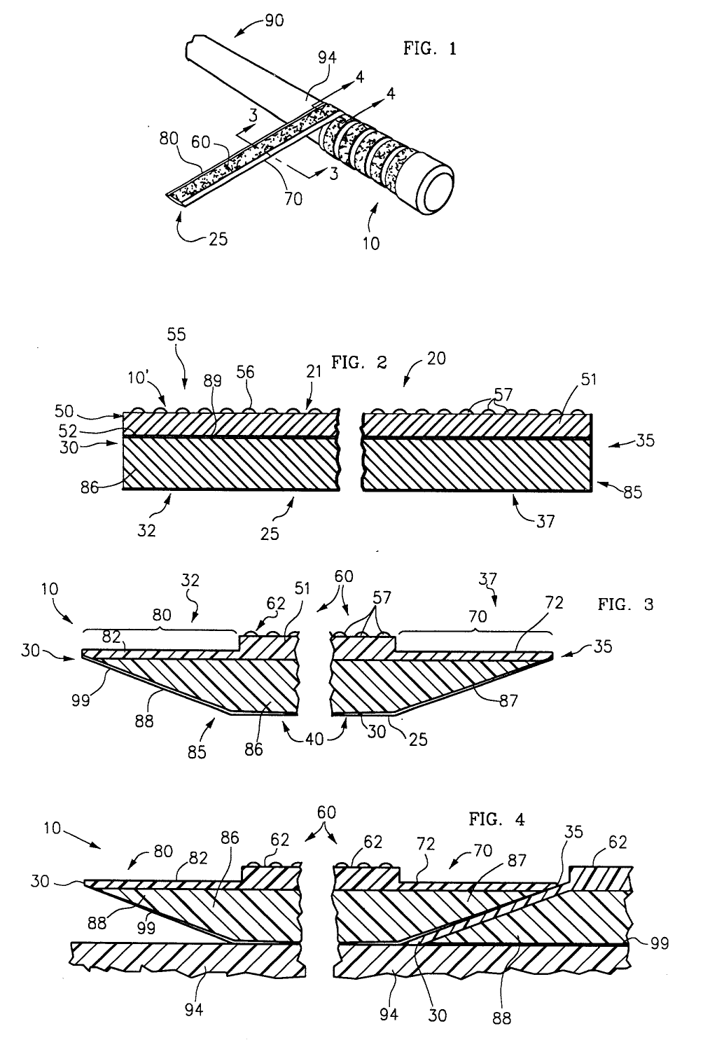

With reference now to the drawings, FIG. 1 is a perspective view of the handle 94 of a sporting racquet 90 with an exemplary embodiment of the tape 10 spiral wound around it according to the invention.

FIG. 2 is an enlarged lateral cross sectional view, partially cut away, of a first embodiment of grip tape 10′. Tape 10′ has a top 20, a bottom 25, a left side 30, a left portion 32 adjacent left side 30, a right side 35, a right portion 37 adjacent right side 35, and a central portion 40. In the embodiment shown in FIG. 2, in lateral cross section, tape 10′ includes an upper portion 50, comprised of rubber 51, and a lower portion 85 of less elastic material than rubber 51, such as an open-pored cloth, such as felt 86, attached to upper portion 50 such as by adhesive 89 or other bonding. Although tape 10′, shown, is rectangular with a generally planar top 20 in lateral cross-section, the teachings of the invention are applicable to other cross sectional configurations as well.

Rubber 51 has a bottom 52 bonded to felt 86 and a top 55 including an outer rubber gripping surface 56 which may include grip-enhancing features, such as grooves, or protuberances or bumps 57. Rubber 51 may be natural rubber, synthetic rubber, such as EPDM or neoprene, or similar material that is very resilient and has a tacky surface. Preferably, entire top 55 is substantially a continuous piece of rubber 51.

FIG. 3 is a lateral cross sectional view taken on line 3-3 of FIG. 1, partially cut away, of the preferred embodiment tape 10 of FIG. 1.

In the preferred embodiment, rubber 51 includes a center portion 60, a right edge portion 70, and a left edge portion 80. Center portion 60 has an upper surface 62 having grip-enhancing features, such as grooves, or protuberances or bumps 57. Right edge portion 70 is to the right of center portion 60 and has an upper surface 72 that is generally lower than upper surface 62 of center portion 60 and extends to right side 35.

Similarly, left edge portion 80 is to the left of center portion 60 and has an upper surface 82 that is generally lower than upper surface 62 of center portion 60 and extends to left side 30.

Felt 86 includes a beveled or skived right portion 87 underlying rubber right portion 70 and a beveled or skived left portion 88 underlying rubber left portion 80. Felt 86 diminishes in thickness outwardly from center portion 40. Felt 86 is skived or beveled, such as by cutting. Felt 86 is described as a preferred material for lower portion 85. Preferably, lower portion 85 is substantially inelastic in the longitudinal direction. Felt 86 is an open-pored cloth having good cushioning qualities and has very little stretch in any direction. Felt 86 is far less elastic than rubber 51. Other possible materials for bottom 85 include non-woven cloth made of nylon fiber, polyester fiber, or combination of different kinds of fibers.

Tape 10 preferably includes adhesive means, such as a layer of glue or two-sided tape 99, on all or part of its lower surface 25 to adhere tape 10 to handle 94.

FIG. 4 is a cross sectional view, partially cut away, taken on line 4-4 of FIG. 1 showing a preferred embodiment of the wrapping of tape 10.

Tape 10 is tensioned and spiral wrapped around handle 94 such that tape 10 flattens against any underlying surface. On each succeeding spiral, right bevel 87 at least partially overlaps top 82 of left edge portion 80 of the previous turn such that right edge portion 70 overlies left edge portion 80 of the previous turn, such that right side 35 of right edge portion 70 is located in a recess below top 62 of central section 60. Preferably, the entire upper surface 72 of right edge portion 70 is disposed below top 62 of the preceeding wrap, as depicted in FIG. 4. The ends of tape 10 are secured in any appropriate manner well-known in the art.

Preferably, also, left upper surface 82 is adapted for being overlapped, such as having a surface adapted for receiving the right skived portion 87, such as being relatively flat.

Felt 86 restricts the stretch of rubber 51 such that rubber 51 maintains a desired thickness and shape during and after wrapping and does not stretch significantly during use such that the racket does not rotate in the user's hand from torque forces.

Dimensions of the elements of tape 10 vary depending upon the application. Typical dimensions for a tennis racquet tape, such as 10, are: width, 20-30 mm; maximum felt thickness, 0.3-1.0 mm, and maximum rubber thickness, 0.5-1.0 mm. In a grip for a hammer handle, not being subject to high torque, rubber 51 may be much thicker, such as 3-8 mm., and provide more total cushioning.

Having described the invention, it can be seen that it provides for an improved grip tape and wrapping method for same. In the description and claims, the terms “left” and “right” have been used for convenience of description and, of course, are reversible as a whole due to symmetry.

Although a particular embodiment of the invention has been illustrated and described, various changes may be made in the form, composition, construction, and arrangement of the parts without sacrificing any of its advantages. Therefore, it is to be understood that all matter herein is to be interpreted as illustrative and not in any limiting sense, and it is intended to cover in the appended claims such modifications as come within the true spirit and scope of the invention.

I claim:

1. A grip tape for wrapping a handle comprising:
an elongate tape having a top, a bottom, a left side and a right side; said tape including:
an upper portion of elastic rubber; and
a lower portion of cloth bonded to said rubber; said cloth being less elastic than said rubber.

2. The grip tape of claim 1 wherein said lower portion is substantially longitudinally inelastic.

3. The grip tape of claim 1 wherein said bottom is two-sided tape bonded to said cloth.

4. The grip tape of claim 1 wherein said lower portion is open-pore cloth.

5. The grip tape of claim 4 wherein said bottom is two-sided tape bonded to said cloth.

6. The grip tape of claim 4 wherein said lower portion is felt.

7. The grip tape of claim 6 wherein said bottom is two-sided tape bonded to said cloth.

8. A grip tape for wrapping a handle comprising:
an elongate tape having a top, a bottom, a left side and a right side; said tape in lateral cross section including:
an upper portion of elastic rubber comprising:
a central portion having an upper surface;
a right edge portion having an upper surface lower than said upper surface of said central portion; and
a left edge portion having an upper surface lower than said upper surface of said central portion; and
a lower portion of cloth bonded to said rubber; said cloth being less elastic than said rubber.

9. The grip tape of claim 8 wherein said lower portion is substantially longitudinally inelastic.

10. The grip tape of claim 8 wherein said bottom includes:
a right portion; said right portion being skived; and
a left portion; said left portion being skived.

11. The grip tape of claim 8 wherein said lower portion is open-pore cloth.

12. The grip tape of claim 11 wherein said lower portion is felt.

13. The grip tape of claim 12 wherein said bottom is two-sided tape bonded to said cloth.

14. In combination:
a handle; and
a grip overlying said handle comprising:
an elongate tape having a top, a bottom, a left side and a right side; said tape in lateral cross section including:
an upper portion of elastic rubber comprising:
a central portion having an upper surface;
a right edge portion having an upper surface lower than said upper surface of said central portion; and
a left edge portion having an upper surface lower than said upper surface of said central portion; and
a lower portion of cloth bonded to said rubber; said cloth being less elastic than said rubber; said tape spiral wrapped around said handle such that said right edge portion overlies said upper surface of said left edge portion of the previous turn.

15. The grip tape of claim 14 wherein said lower portion is substantially longitudinally inelastic.

16. The grip tape of claim 14 wherein said bottom includes:
a right portion; said right portion being skived; and
a left portion; said left portion being skived.

17. The grip tape of claim 14 wherein said lower portion is open-pore cloth.

18. The grip tape of claim 17 wherein said bottom includes:
a right portion; said right portion being skived; and
a left portion; said left portion being skived.n

19. The grip tape of claim 18 wherein said lower portion is felt.

20. The grip tape of claim 18 wherein said bottom is two-sided tape bonded to said cloth.
